(19) United States
(12) Patent Application Publication
(10) Pub. No.: US 2002/0143857 A1
(43) Pub. Date: Oct. 3, 2002

(54) Method and system for event communication on a distributed scanner/workstation platform

(76) Inventors: Phani Kumar Bidarahalli, Waukesha, WI (US); Christopher J. Mussack, Waukesha, WI (US); Peter Lehel, Waukesha, WI (US)

Correspondence Address: QUARLES & BRADY LLP, 411 E. WISCONSIN AVENUE, SUITE 2040, MILWAUKEE, WI, 53202-4497, US

(21) Appl. No.: 09/681,422

(22) Filed: Mar. 30, 2001

(51) Int. Cl. G06F 15/16; G06F 9/46

(52) U.S. Cl. 709/203; 709/318

(57) ABSTRACT

A system and method are disclosed for event communication on a distributed scanner/workstation platform. In one embodiment, a medical imaging system having at least one host further includes a first application, a second application, and an event name service. The first application is at the at least one host, and is a first event source. The second application is at the at least one host, and is a first event listener capable of receiving a first event provided from the first application. The event name service is in communication with the first and second applications. At least one of the first and second applications is capable of registering with the event name service.

### BACKGROUND OF INVENTION

The field of the invention is medical imaging methods and systems. More particularly, the invention relates to a method and system that allows for reliable and seamless delivery of events in a distributed medical imaging scanner and workstation platform having multiple hosts using one or more languages.

During typical operation of a medical imaging system having a scanner/workstation platform, many events are generated and received, where events are self-describing data packets provided between different applications (high level programs). Traditionally, a scanner/workstation platform was implemented on a single host computer. Further, the applications running on the host were typically programmed in the C++ language or another C-type language. Because of the structural simplicity of such systems and the degree to which the various elements of such systems shared the same communication protocols, event delivery between applications in such systems could be performed easily and rapidly, without the use of any specialized communication techniques.

However, new generation scanner/workstation platforms have become increasingly complex in their structure and operation. Many of these scanner/workstation platforms employ multiple hosts, use multiple architectures (e.g., little endian/big endian) and use multiple languages such as C++ or JAVA (for implementing user interfaces). Further, as scanner/workstation platforms have become integrated with the internet, the scanner/workstation platforms have further begun to employ and/or interact with applets and other internet protocols.

As a result of this increasing complexity of scanner/workstation platforms, the communication of events between applications running on the scanner/workstation platforms also has become increasingly complicated. In particular, the programming of applications will desirably take into account all of the intricacies affecting data transfer between applications that result from the use of multiple hosts, multiple architectures, and multiple languages, including internet communications protocols. Although such programming of applications that takes into account all of these intricacies is possible, such programming is complex and costly, and the resulting operation of scanner/workstation platforms is often slow and at times unreliable. Thus, programming to allow event communication using traditional methods requires a great deal of software knowledge on the part of the software programmer, and is difficult for the non-serious programmer (e.g., researchers who utilize the medical imaging systems).

It would therefore be advantageous if a system could be developed that allowed the applications running on medical imaging system scanner/workstation platform(s) to easily and reliably communicate events between one another, even when the scanner/workstation platform(s) included multiple hosts or employed multiple architectures. It would further be advantageous if such a system also allowed for easy and reliable communication of events between applications even when the applications were programmed in different computer languages. It would additionally be advantageous if such a system allowed for easy and reliable communication of events even between applications and applets, or between the applications of the scanner/workstation platforms and the internet.

### SUMMARY OF INVENTION

The present invention relates to a medical imaging system having at least one host, and further including a first application, a second application, and an event name service. The first application is at the at least one host, and is a first event source. The second application is at the at least one host, and is a first event listener capable of receiving a first event provided from the first application. The event name service is in communication with the first and second applications. At least one of the first and second applications is capable of registering with the event name service.

The present invention further relates to, in a medical imaging system, a system for communicating information that includes a plurality of event source applications, a plurality of event listener applications, a hosting means, and an event name service at which the event listener applications can register. The event source applications are capable of providing events, as publishers, to event listener applications. The event listener applications are capable of receiving, as subscribers, at least some of the events from the event source applications, using an event filtering mechanism. The hosting means is for hosting at least one of the plurality of event source and event listener applications. The event source applications only provide the events to the event listener applications if the event listener applications have registered for the events with the event name service.

The present invention additionally relates to in a medical imaging system, a method of communicating information. The method includes providing a first application that is an event listener, a second application that is an event source, and an event name service, and registering at least one of the event listener and the event source with the event name service. The method further includes sending an event from the event source to the event listener when the at least one of the event listener and the event source is registered with the event name service.

The present invention additionally relates to a method of communicating information on a distributed medical imaging scanner/workstation platform. The method includes providing a first event source on a first host of the platform, providing a first event listener on a second host of the platform, and registering the first event source at an event name service. The method further includes providing a listing of the first event source and a second event source in response to a request, determining whether a desired event source capable of providing a desired event as required by the first event listener is registered and, when the desired event source is registered, firing the desired event from the desired event source to the first event listener.

### BRIEF DESCRIPTION OF DRAWINGS

FIG. 1 is a schematic block diagram showing the interaction of applications on an exemplary distributed scanner/workstation that are operating to communicate events;

FIG. 2 is a schematic block diagram showing libraries used by the system of FIG. 1;

FIG. 3 is a schematic block diagram showing interfaces and objects within a DEMIDL C++ library of FIG. 2; and

FIGS. 4-6 are schematic block diagrams showing wrapper classes within a DEM C++ library of FIG. 2; and

FIGS. 7-10 are interaction diagrams showing the operation of APIs that allow communication of events between the applications of FIG. 1.

### DETAILED DESCRIPTION

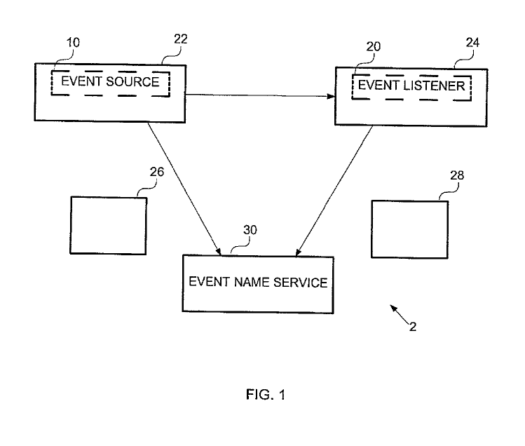

Referring to FIG. 1, a block diagram is provided showing schematically how applications of a distributed medical imaging scanner/workstation platform 2 communicate events among one another. As shown, an application that is a source of events, namely, an event source 10, runs on a first host 22. The event source 10 can provide one or more events to an application that listens to events, namely, an event listener 20, shown to be running on a second host 24. Additionally, each of the event source 10 and the event listener 20 are in communication with a centralized location for discovering event services, namely, an event name service 30. The event name service 30 can exist on the first host 22, the second host 24, or elsewhere.

FIG. 1 is meant to be generally representative of any pair of applications running on a given medical imaging system. As shown, the two applications can be applications that are hosted by two different hosts, which can exist on either a single medical imaging system device, or on two separate medical imaging devices. In alternate embodiments, the two applications can exist on a single host. In further alternate embodiments, the first application (i.e., the event source 10) is hosted by a medical device that is in communication with the second application of a second device by way of the internet. For generality, the scanner/workstation platform 2 of FIG. 1 is shown to have additional hosts 26, 28 on which other applications can exist and communicate with one another.

The two application programs that are communicating can also be operating on hosts that use different or multiple architectures (e.g., little Endian/big Endian), or can be hosted by hosts using a single architecture. Each of the event source 10 and the event listener 20 can be operating by way of any of a number of languages, such as C++ or Java. If the event source 10 is located on a different medical imaging device than the event listener 20, those two devices can be coupled by any one of a number of communication links, including the internet. The scanner/workstation platform 2 can include medical imaging devices of a variety of types, for example, magnetic resonance imaging (MRI) systems, CT systems, positron emission tomography (PET) scanner systems, x-ray scanners and nuclear imaging scanners.

The one or more events that are communicated between the event source 10 and the event listener 20 can be any sets of data that provide both substantive data and self-describing data. That is, the information being provided as an event should include information indicating how that information is to be operated upon. The events can range from simple strings (e.g., “hello”) to complex arrays of values as well as to data having a variety of other formats.

One example of the first host 22 for the event source 10 would be a medical imaging scanner that has obtained a scanned image and has stored it on its database after a patient was scanned. In such case, an application of that medical imaging scanner might receive a request from an application running on another device, such as a printer, to provide the scanned information. In such case, if the information was transmitted from the medical imaging scanner to the printer, the event source 10 would be an application on the medical imaging scanner and the event listener 20 would be an application program on the printer.

As shown by FIG. 1, the event name service 30 is in communication with both the event source 10 and the event listener 20. The event listener 20 is able to access information from the event name service 30 in the form of a list of all event sources of the scanner/workstation platform 2, which often will have multiple event sources operating simultaneously. The event name service 30 is further able to identify the event source or sources that could have generated any given particular event. The event name service 30 also acts as a surrogate for event sources that have not yet come on line. In such case where an event source has just come on line after being off line, the event name service 30 ceases to act as a surrogate. The event name service 30 operates as a single application that couples all of the hosts that are hosting the different applications that are potentially event sources or event listeners.

The relationship between the event source 10 and the event listener 20 occurs in accordance with a subscriber-publisher model by way of a distributed call back technique. At any given time, any given application can act as a publisher (that is, an event source) or as a subscriber (that is, an event listener). Applications that are the publishers (event sources) implement Application Program Interfaces (APIs) that are well-known to those skilled in the art, and that allow subscribers (event listeners) to register or unregister with the publishers. Further, the publishers employ well-known APIs to fire events in a multi-cast mode or to a group of subscribers that satisfy a filter criterion that is determined by the event name service 30. The subscribers for event listeners 20 implement well-known APIs that are invoked when events are being fired. The subscribers can further set the filters at the event name service 30, which indicate the kinds of events that the subscribers are interested in listening to or receiving. The filters can be simple restrictive filters that only allow a particular one of the events to be provided to a given subscriber, or be more complicated and allow certain combinations of events to be provided to a subscriber. The subscribers and publishers across the network can be located by the use of well-known service locator programs.

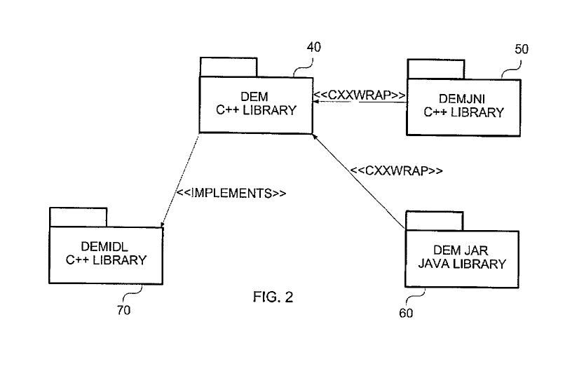

Turning to FIG. 2, a package diagram of a software framework used by the applications for communicating events on the distributed scanner/workstation platform 2 is provided. The language used by and among the various applications is typically the CORBA language, which is a distributed communication standard well-known in the art. However, in alternate embodiments, other languages can be used.

As shown in FIG. 2, the package diagram includes a DEM C++ library 40, which provides convenient wrapper methods and APIs that are in C++, which implement application level interfaces. The DEM C++ library 40 includes a DEMJNI C++ library 50 and a DEMjar Java library 60, which are the generated packages. The DEMJNI C++ library 50 contains cxxwrap generated C++ interfaces that are used by Java applications. The DEMjar library 60 contains Java APIs.

In the embodiment shown, each of the DEMJNI C++ library 50 and the DEMjar Java library 60 are in the Java native interface (JNI) format, which allows translation between the Java language and the C++ language. The DEM C++ library 40 further includes a DEMIDL C++ library 70, which implements the application level interfaces that provide the communication mechanisms for communication between different applications. The DEMIDL C++ library 70 defines the basic set of IDL interfaces, which are in the CORBA distributed communication standard. Although the package diagram of FIG. 2 includes C++ libraries and Java libraries and is configured for operation in accordance with the CORBA standard, in alternate embodiments, the particular languages and communication standards can vary.

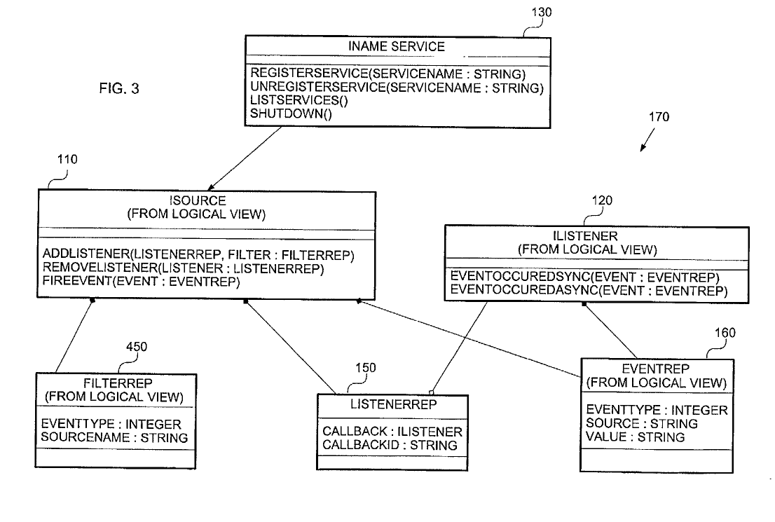

Turning to FIG. 3, an exemplary DEMIDL package 170 that could be found within the DEMIDL C++ library 70 is provided. The DEMIDL package 170 is shown to include three interfaces, an ISource interface 110, an Listener interface 120 and an IName Service interface 130. The ISource interface 110 is the interface that all event sources should implement, either directly or by way of an object that is included within the event source. The IListener interface 120 is the interface that all event listeners should implement. The IName Service interface 130 is the interface that provides name lookup for the event sources and event listeners.

Also included within the DEMIDL package is a FilterRep class 140, a ListenerRep class 150 and an EventRep class 160. Each of the FilterRep class 140 and the ListenerRep class 150 are used by the ISource interface 110. The FilterRep class 140 enables the event listener 20 to get called only when a desired type of event occurs.

The FilterRep class 140 can be used as a single class or can be subclassed. The ListenerRep class 150 is a callback object that allows the event source 10 to fire an event to the event listener 20. The EventRep class 160 is the base event that is delivered to the event listener 20 from the event source 10, and is utilized by the IListener interface 120. The ListenerRep class 150 is also in communication with the Listener interface 120, so that the ISource interface 10 can determine when to fire an event to the event listener 20 from the event source 10. The IName service interface 130 is in communication with the ISource interface 110, and the IName Service interface supports the number of APIs as shown.

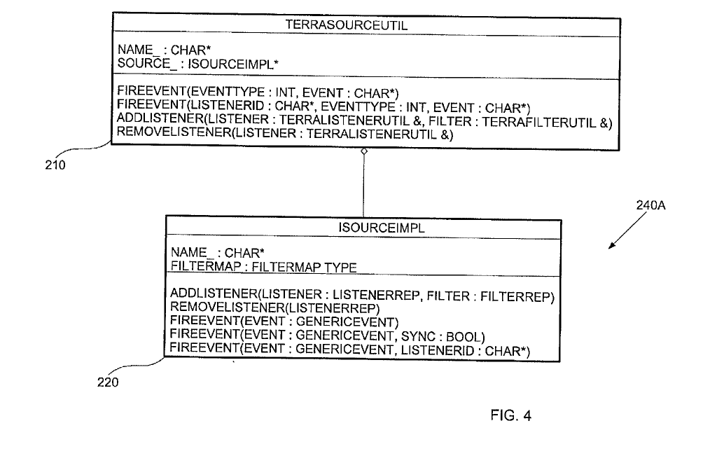

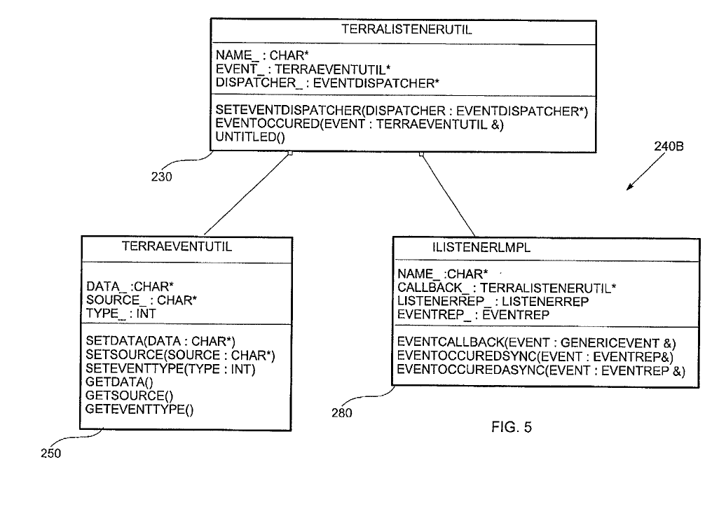

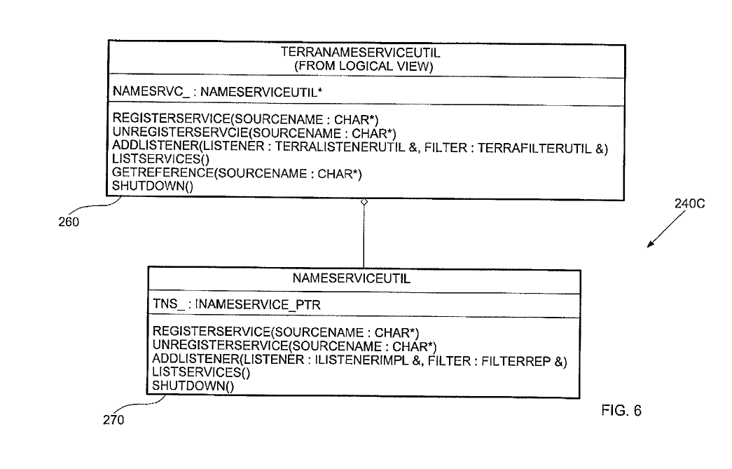

Turning to FIGS. 4-6, three sections 240a, 240b and 240c of an exemplary DEM package 240 are provided. The DEM package 240 corresponds to, and could be found or contained in the DEM C++ library 40. As shown, the DEM package 240 includes three classes: a TerraSourceUtil class 210 shown in section 240a in FIG. 4; a TerraListenerUtil class 230 shown in section 240b in FIG. 5; and a TerraNameServiceUtil class 260 shown in section 240c in FIG. 6. The TerraSourceUtil class 210 is a wrapper class that defines the APIs that are to be implemented for any application that is an event source, such as event source 10. The TerraSourceUtil class 210 provides a default implementation of these APIs, which can vary depending upon the embodiment. Additionally, the TerraSourceUtil class 210 hides all CORBA details and provides a simple and easy-to-use interface.

The TerraListenerUtil class 230 is a wrapper class that provides a mechanism for an event listener of a particular event (such as the event listener 20) to obtain or receive the event. The TerraListenerUtil class 230 employs a pointer (in this case, called “EventDispatcher”) to allow the event listener 20 to get to the contents of the event. With respect to the TerraNameServiceUtil class 260, this is a singleton class that provides possible source references to event listeners, and is the centralized name server. The various event sources such as event source 10 are expected to register with the TerraNameServiceUtil class 260. Also, the TerraNameServiceUtil class 260 can register event listeners, such as event listener 20, that are waiting for particular event sources, before the event sources come up.

As shown in Figs. the TerraSourceUtil class 210 includes an ISourcelmpl subclass 220, and the TerraListenerUtil class 230 includes a TerraEventUtil subclass 250 and an IListenerlmpl subclass 280. As shown in FIG. 6, the TerraNameServiceUtil class 260 includes a NameServiceUtil subclass 270. Every event listener 20 includes the TerraListenerUtil class 230 and the subclasses 250 and 280; every event source 210 includes the TerraSourceUtil class 210 and the ISourcelmpl subclass 220, and every event name service 30 includes the TerraNameServiceUtil class 260 and the NameServiceUtil subclass 270. The DEMJNI C++ library 50 and the DEMjarJava library 60 include similar classes and subclasses that differ from those of FIGS. 4-6 for the most part only insofar as the class and subclass information in the DEM package 240 of FIGS. 4-6 has been wrapped by the cxxwrap program.

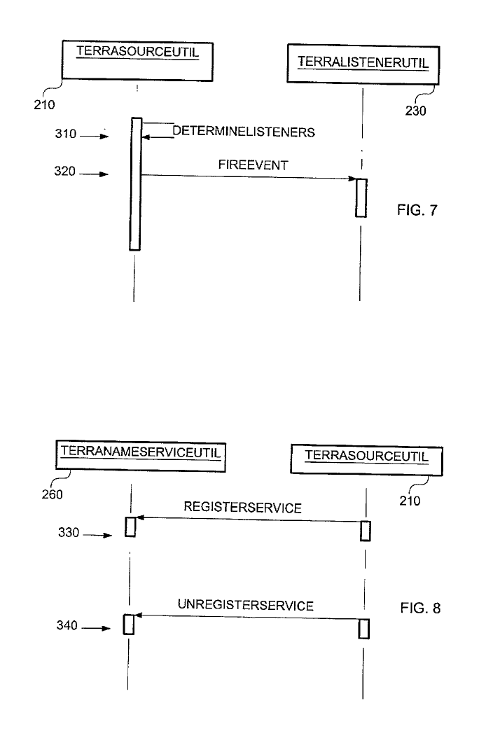

Referring to FIG. 7, an interaction diagram shows an exemplary interaction between the TerraSourceUtil class 210 of the event source 10 and the TerraListenerUtil class 230 of the event listener 20 during the firing of an event from the event source to the event listener. As shown, the interaction includes a first step 310, at which the TerraSourceUtil class 210 determines which event listeners are awaiting for an event, and a second step 320, at which the TerraSourceUtil class 210 fires the particular event to the TerraListenerUtil class 230 of the appropriate listeners, which in this case include the event listener 20. Turning to FIG. 8, an interaction diagram shows exemplary interactions between the TerraNameServiceUtil 260 and the TerraSourceUtil 210 of the event name service 30 and the event source 10, respectively, during the registering and unregistering of the event source with the event name service. As shown, the TerraSourceUtil class 210 can send either a register service command to the TerraNameServiceUtil class 260 at step 330, or an unregister service command to the TerraNameServiceUtil class at step 340, which respectively causes either the registering or unregistering of the event source 10 at the event name service 30, respectively.

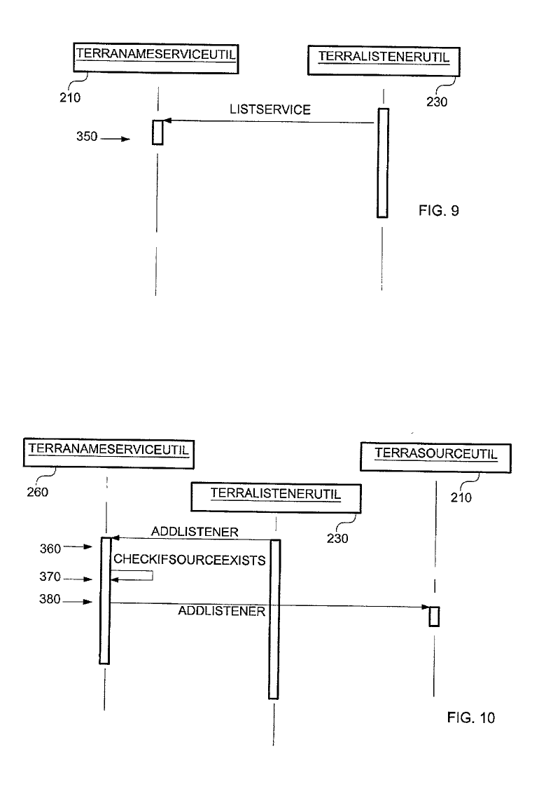

Referring to FIG. 9, an interaction diagram shows how the TerraListenerUtil class 230 of the event listener 20 can contact the TerraNameServiceUtil class 210 of the event name service 30, in order to send information that the event listener is interested in receiving a particular type of event. To do this, a list service command is provided from the TerraListenerUtil class 230 to the TerraNameServiceUtil class 210 at step 350.

Referring to FIG. 10, an interaction diagram shows how the event listener 20 is able to register for receiving an event even when an event source that is capable of providing the event is not yet present. In this case, the event name service 30 acts as surrogate or proxy for the desired event source, and transfers the registration once the event source comes on line. As shown, the TerraListenerUtil class 230 provides an add listener command at step 360 to the TerraNameServiceUtil 260 of the event name service 30. At step 370, the event name service determines if a desired event source for providing the desired event currently exists or is on line. Once the desired event source comes on line, the TerraNameServiceUtil class 260 provides an add listener command at step 380 to the TerraSourceUtil class 210 of the event source (e.g., the event source 10).

The embodiments shown in FIGS. 1-10 are meant to be exemplary of a variety of different embodiments in which one or more event listeners are in communication with one or more event sources, by way of one or more event name services. The embodiments shown allow applications corresponding to the event sources and event listeners that are written in either C++ or Java to operate by way of the same programming interface. Further, the embodiments shown scale easily for applications that are on multiple hosts and are written in multiple languages or utilize applet communications.

While the foregoing specification illustrates and describes the preferred embodiments of this invention, it is to be understood that the invention is not limited to the precise construction herein disclosed. The invention can be embodied in other specific forms without departing from the spirit or essential attributes of the invention. Accordingly, reference should be made to the following claims, rather than to the foregoing specification, as indicating the scope of the invention.

1] A medical imaging system having at least one host, and further comprising:
a first application at the at least one host, the first application being a first event source;
a second application at the at least one host, the second application being a first event listener capable of receiving a first event provided from the first application; and
an event name service in communication with the first and second applications, wherein at least one of the first and second applications is capable of registering with the event name service.

2] The system of claim 1, wherein the at least one host includes a first host and a second host, wherein the first application is at the first host and the second application is at the second host, and wherein first and second hosts differ in at least one of their respective languages, their respective architectures, or the respective devices on which the respective hosts reside.

3] The system of claim 1, wherein the communication of the first event between the first and second applications occurs by way of the internet, and at least one of the first and second applications includes applets.

4] The system of claim 1, wherein the application that is capable of registering with the event name service is also capable of deregistering from the event name service.

5] The system of claim 1, further comprising a plurality of additional hosts at which are a plurality of additional applications, wherein each of the additional applications is either an event source or an event listener.

6] The system of claim 5, wherein at least some of the additional applications are additional event listeners, and wherein the first event source determines whether to provide the first event to the first event listener and the additional event listeners based upon a filter determined by the event name service in response to the registering of at least some of the first event listener and the additional event listeners at the event name service.

7] The system of claim 5, wherein at least some of the additional applications are additional event listeners, and wherein the first event source provides the first event to the first event listener and each of the additional event listeners in a multicast mode of operation.

8] The system of claim 5, wherein at least some of the additional applications are additional event sources, and wherein the first event listener is capable of providing a command to the event name service to provide a listing of the first event source and the additional event sources that are currently active.

9] The system of claim 1 wherein, when the first event listener registers with the event name service to receive the first event but the first event source is not yet on line, the event name service acts as a proxy for the first event source until such time as the first event source becomes on line.

10] The system of claim 1, wherein the first and second applications each employ a package including a DEM C++ library, a DEMIDL C++ library, a DEMJNI C++ library, and a DEMjarjava library.

11] The system of claim 10, wherein each DEM C++ library includes a DEM package including a TerraSourceUtil class, a TerraListenerUtil class, and a TerraNameServiceUtil class, wherein each TerraSourceUtil class includes an Isourcelmpl subclass, wherein each TerraListenerUtil class includes a TerraEventUtil subclass and an Ilistenerlmpl subclass, and wherein each TerraNameServiceUtil class includes a NameServiceUtil subclass.

12] The system of claim 10, wherein each DEMIDL C++ library includes a DEMIDL package that comprises an INameService class, an ISource class, and an Listener class, wherein the INameService class is implemented in the event name service, the ISource class is implemented in the first event source and owns a FilterRep class and a ListenerRep class, wherein the ListenerRep class is also in association with the IListener class, and wherein the IListener class is implemented in the first event listener and owns an EventRep class.

13] The system of claim 1, wherein the medical imaging system is one of an MRI medical imaging system, a CT system, a PET medical imaging system, an x-ray scanner and a nuclear imaging scanner.

14] In a medical imaging system, a system for communicating information comprising:
a plurality of event source applications, the event source applications being capable of providing events, as publishers, to event listener applications;
a plurality of event listener applications, the event listener applications being capable of receiving, as subscribers, at least some of the events from the event source applications using an event filtering mechanism;
a hosting means for hosting at least one of the plurality of event source and event listener applications; and
an event name service at which the event listener applications can register, wherein the event source applications only provide the events to the event listener applications if the event listener applications have registered for the events with the event name service.

15] The system of claim 13, wherein at least one of the event source applications and one of the event listener applications are located on a single host device, the single host device being included in a hosting means, and wherein the language employed in the communication of the event is CORBA.

16] The system of claim 13, wherein one of the event source applications is located on a different host device than one of the event listener applications, and one of the event source applications employs a different architecture and a different language than one of the event listener applications.

17] In a medical imaging system, a method of communicating information, the method comprising:
providing a first application that is an event listener, a second application that is an event source, and an event name service;
registering at least one of the event listener and the event source with the event name service; and
sending an event from the event source to the event listener when the at least one of the event listener and the event source is registered with the event name service.

18] The method of claim 17, wherein the registering of the at least one of the event listener and the event source with the event name service is the registering of the event listener with the event name service, and further comprising:
determining whether a particular event source for providing a desired event currently exists;
providing a proxy for the particular event source because the particular event source is currently not on line, wherein the proxy is provided by the event name service; and
transferring a registration from the proxy to the particular event source when the particular event source comes on line.

19] The method of claim 17, further comprising:
providing a listing of registered event sources; and
unregistering the at least one of the event listener and the event source from the event name service.

20] A method of communicating information on a distributed medical imaging scanner/workstation platform, the method comprising:
providing a first event source on a first host of the platform;
providing a first event listener on a second host of the platform;
registering the first event source at an event name service;
providing a listing of the first event source and a second event source in response to a request;
determining whether a desired event source capable of providing a desired event as required by the first event listener is registered; and
when the desired event source is registered, firing the desired event from the desired event source to the first event listener.
